(19) United States
(12) Patent Application Publication
(10) Pub. No.: US 2025/0001928 A1
(43) Pub. Date: Jan. 2, 2025

(54) HEADLAMP AUTO LEVELING SYSTEM FOR MOBILE AND CONTROL METHOD THEREOF

(71) Applicant: HYUNDAI MOBIS CO., LTD., Seoul (KR)

(72) Inventor: Myeong Je KIM, Seoul (KR)

(73) Assignee: HYUNDAI MOBIS CO., LTD., Seoul (KR)

(21) Appl. No.: 18/498,855

(22) Filed: Oct. 31, 2023

(30) Foreign Application Priority Data
Jun. 27, 2023 (KR) 10-2023-0082460

(51) Int. Cl. B60Q 1/115; G06T 5/80

(52) U.S. Cl. CPC B60Q 1/115; G06T 5/80; B60Q 2300/13

(57) ABSTRACT

A headlamp auto leveling system for a mobile (i.e., vehicle) includes a headlamp, the system including: a leveling module controlling an inclination of the headlamp; a sensor unit including at least one of a light detection and ranging (LiDAR), a radar, and a camera providing information on a surrounding environment of the mobile; and a control unit calculating a three-dimensional (3D) inclination of the mobile with respect to a ground based on detection data received from the sensor unit, and controlling the leveling module based on the 3D inclination of the mobile, wherein the control unit calculates plane data for a predetermined surrounding region of the mobile from the detection data received from the sensor unit, and calculates the 3D inclination of the mobile by comparing predetermined reference plane data with the calculated plane data.

### CROSS-REFERENCE TO RELATED APPLICATIONS

This application claims priority under 35 U.S.C. § 119 to Korean Patent Application No. 10-2023-0082460, filed on Jun. 27, 2023, in the Korean Intellectual Property Office, the disclosure of which is incorporated herein by reference in its entirety.

### TECHNICAL FIELD

The following disclosure relates to a headlamp auto leveling system for a mobile (vehicle) and a control method thereof.

### BACKGROUND

A headlamp leveling control system of a vehicle may automatically adjust a height of a headlamp based on a change in altitude during driving of the vehicle to help a driver of the vehicle and drivers of other vehicles to drive their vehicles safely. The headlamp leveling control system may usually detect changes in the inclination or weight of the vehicle, an acceleration sensor in the vehicle, or the like, and adjust the headlamp to maintain a constant height based thereon. Through this system, it is possible to adjust an emission direction of the headlamp even during the driving to secure a wide range of visibility, thereby preventing glare from occurring in the drivers of other vehicle, which may improve the drivers' safety during the driving.

FIG. 1 is a schematic view showing a conventional headlamp auto leveling system.

As shown in FIG. 1, the headlamp leveling control system may be normally operated in connection with an electronic control system (ECU) of a vehicle. Here, the axle sensor or height sensor 10 of the vehicle may serve to detect the inclination of the vehicle, an axle may be a central part of the vehicle crossing its central axis, and the axle sensor 10 may be installed around the axle. Through this configuration, the system may control leveling of the vehicle by estimating an inclination angle of the headlamp.

However, it may cause an error and may be not intuitive when detecting the inclination of the vehicle by using the conventional axle sensor 10 because an inclination of the headlamp is estimated through an inclination of the axle. In addition, a dedicated height sensor may be required to detect the inclination of the axle, which may increase material costs.

### SUMMARY

An embodiment of the present disclosure is directed to providing a headlamp auto leveling system for a mobile which may use an advanced driver assistance system (ADAS) sensor replacing a height sensor to detect a three-dimensional inclination of a vehicle body, and may precisely control leveling of the mobile based thereon, and a control method thereof.

In one general aspect, provided is a headlamp auto leveling system for a mobile that includes a headlamp, the system including: a leveling module controlling an inclination of the headlamp; a sensor unit including at least one of a light detection and ranging (LiDAR), a radar, and a camera providing information on a surrounding environment of the mobile; and a control unit calculating a three-dimensional (3D) inclination of the mobile with respect to a ground based on detection data received from the sensor unit, and controlling the leveling module based on the 3D inclination of the mobile, wherein the control unit calculates plane data for a predetermined surrounding region of the mobile from the detection data received from the sensor unit, and calculates the 3D inclination of the mobile by comparing predetermined reference plane data with the calculated plane data.

The control unit may calculate P1 to Pn, which are coordinates of the ground of the predetermined surrounding region, based on the predetermined surrounding region of the mobile, and calculate the plane data for a plane including the coordinates P1 to Pn.

The control unit may calculate the 3D inclination of the mobile by comparing a predetermined reference normal of the calculated plane data with a predetermined reference normal of the reference plane data.

The control unit may calculate the 3D inclination of the mobile by comparing a predetermined center of gravity of the calculated plane data with a predetermined center of gravity of the reference plane data.

The control unit may calculate the 3D inclination of the mobile by comparing a predetermined area of the calculated plane data with a predetermined area of the reference plane data.

The control unit may calculate the plane data from the detection data received from the at least two or more sensors, and calculate the 3D inclination of the mobile by comparing a predetermined center point of the calculated plane data with a predetermined center point of the reference plane data.

The control unit may control the leveling module to individually control each of angles of the plurality of headlamps based on the calculated 3D inclination of the mobile.

The control unit may further calculate position information of an object positioned in front of the mobile based on the detection data received from the sensor unit, set a dark zone based on the calculated position information of the object, and correct a position of the dark zone by reflecting the calculated 3D inclination of the mobile.

The control unit may estimate distortion of an image projected in front of the mobile based on the calculated 3D inclination, and correct the image to be in a direction opposite to that of the estimated distortion.

In another general aspect, provided is a control method of a headlamp auto leveling system for a mobile that includes a leveling module and a sensor unit, the method including: (a) receiving, by a control unit, detection data from the sensor unit; (b) calculating, by the control unit, a three-dimensional (3D) inclination of the mobile with respect to a ground based on the received detection data; and (c) controlling, by the control unit, the leveling module based on the calculated 3D inclination of the mobile, wherein in the step (b), plane data for a predetermined surrounding region of the mobile is calculated from the detection data received from the sensor unit, and the 3D inclination of the mobile is calculated by comparing predetermined reference plane data with the calculated plane data.

In the step (b), P1 to Pn, which are coordinates of the ground of the predetermined surrounding region may be calculated based on the predetermined surrounding region of the mobile, and the plane data for a plane including the coordinates P1 to Pn may be calculated.

In the step (b), the 3D inclination of the mobile may be calculated by comparing any one of the predetermined reference normal, center of gravity, and area of the calculated plane data with any one of the predetermined reference normal, center of gravity, and area of the reference plane data, respectively.

The step (c) may include: determining a first angle of the calculated 3D inclination that is an inclination to a first reference axis and a second reference axis which is an axis perpendicular to the first reference axis; controlling upper and lower sides of the leveling module when the first angle has a predetermined reference or more; determining a second angle of the calculated 3D inclination that is an inclination to the second reference axis and a third reference axis which is an axis perpendicular to the second reference axis; and controlling left and right sides of the leveling module when the second angle has a predetermined reference or more.

### BRIEF DESCRIPTION OF THE DRAWINGS

FIG. 1 is a schematic view showing a conventional headlamp auto leveling system.

FIG. 2 is a schematic view showing a headlamp auto leveling system for a mobile according to the present disclosure.

FIGS. 3A and 3B are schematic views to compare the conventional headlamp auto leveling system with the headlamp auto leveling system according to the present disclosure.

FIG. 4 is a schematic view showing an example of mounting an advanced driver assistance system (ADAS) sensor according to the present disclosure.

FIG. 5 is a schematic view showing Example 1 of a method for estimating an inclination of a mobile according to the present disclosure.

FIG. 6 is a schematic view showing Example 2 of the method for estimating an inclination of a mobile according to the present disclosure.

FIG. 7 is a schematic view showing Example 3 of the method for estimating an inclination of a mobile according to the present disclosure.

FIG. 8 is a flowchart showing a control method of a headlamp auto leveling system for a mobile according to the present disclosure.

FIG. 9 is a flow chart showing FIG. 8 in more detail.

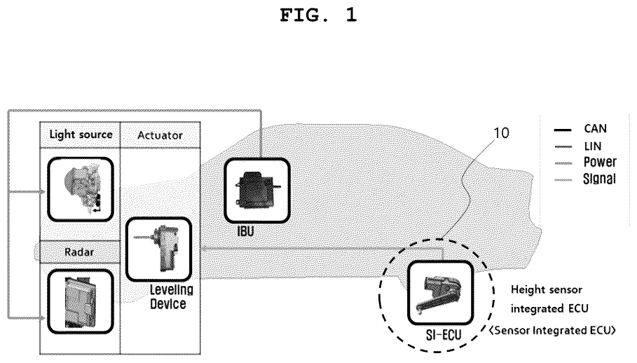

### DETAILED DESCRIPTION

In order to describe the present disclosure, operational advantages of the present disclosure, and objects accomplished by embodiments of the present disclosure, the embodiments of the present disclosure are hereinafter exemplified and described with reference to the accompanying drawings.

First, terms used in this application are used only to describe specific embodiments rather than limiting the present disclosure, and a term of a singular number may include its plural number unless explicitly indicated otherwise in the context. In addition, it is to be understood that a term “include”, “have”, or the like used in this application specifies the existence of features, numerals, steps, operations, components, parts, or combinations thereof, which are mentioned in the specification, and does not preclude the existence or addition of one or more other features, numerals, steps, operations, components, parts, or combinations thereof.

When it is decided that the detailed description of the known configuration or function related to the present disclosure may obscure the gist of the present disclosure, the detailed description thereof will be omitted.

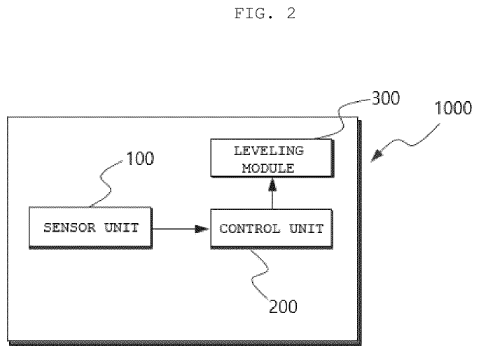

FIG. 2 is a schematic view showing a headlamp auto leveling system for a mobile according to the present disclosure.

As shown in FIG. 2, the headlamp auto leveling system according to the present disclosure may include a sensor unit 100, a control unit 200, and a leveling module 300.

The sensor unit 100 may include at least one sensor detecting a distance from the mobile to a ground surface. Here, the sensor unit 100 may detect distances to a plurality of points. In detail, the sensor unit 100 may include an advanced driver assistance system (ADAS) sensor, and in more detail, the ADAS sensor may include any one of a light detection and ranging (LiDAR), a radar, and a camera.

The leveling module 300 may control an inclination of a headlamp.

The control unit 200 may generate a plurality of position coordinates based on the distances to the plurality of points, received from the sensor unit 100. In addition, the control unit 200 may control the leveling module 300 based on the generated plurality of position coordinates.

In detail, the control unit 200 may generate at least three position coordinates P1 to Pn based on detection data received from the sensor unit 100, and calculate a three-dimensional (3D) inclination of the mobile, which is the three-dimensional inclination of the front, rear, left, and right of the mobile with respect to X, Y, and Z axes based on the generated position coordinates of three or more points.

In this case, the X, Y, and Z axes may here be axes perpendicular to one another, and the three-dimensional inclination may be the three-dimensional inclination of the mobile with respect to the ground.

In more detail, the control unit 200 may calculate plane data for a predetermined surrounding region of the mobile from the detection data received from the sensor unit 100, and calculate the 3D inclination of the mobile by comparing the calculated plane data with predetermined reference data.

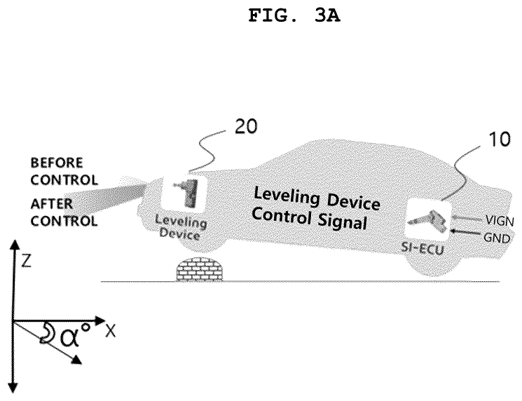

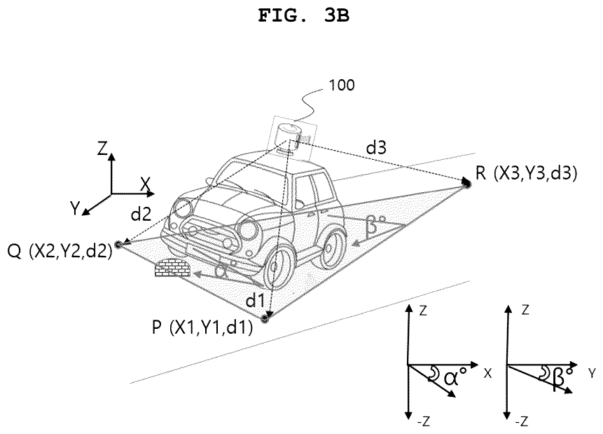

Meanwhile, FIGS. 3A and 3B are schematic views to compare the conventional headlamp auto leveling system with the headlamp auto leveling system according to the present disclosure.

FIG. 3A shows the conventional headlamp auto leveling system, and the conventional system may require a height sensor (or SI-ECU) 10 to adjust the inclination of the headlamp based on the inclination of the mobile. When the height sensor 10 detects the inclination and transmits a control signal to a leveling module 20, the conventional system may adjust the inclination of the lamp based on the control signal received by the leveling module 20. Here, as shown in FIG. 3A, the conventional headlamp auto leveling system may detect only the front and rear inclination of the mobile, and may not detect the left and right inclination of the mobile even when the left and right inclination is included in the received signal.

On the other hand, FIG. 3B shows the headlamp auto leveling system 1000 for a mobile according to the present disclosure, the system 1000 may use the ADAS sensor as in the present disclosure to detect not only the front and rear inclination of the mobile but also the left and right inclination of the mobile. In detail, the system 1000 may thus adjust the inclination of the lamp based on the three-dimensional inclination of the mobile, and more precisely control leveling of the mobile.

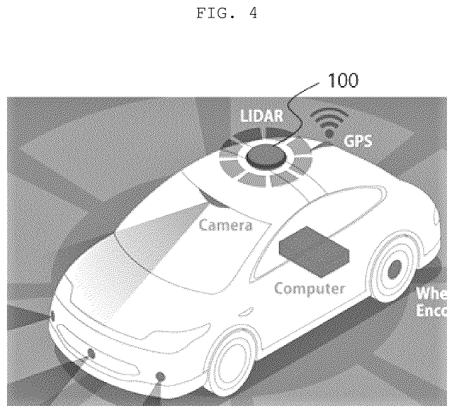

FIG. 4 is a schematic view showing an example of mounting an advanced driver assistance system (ADAS) sensor according to the present disclosure.

Hereinafter, the description describes the ADAS sensor in detail.

First, the advanced driver assistance system (ADAS) may be an intelligent driver assistance system, and may be a driver assistance system in which the vehicle itself recognizes and determines some situations during its driving by using an advanced detection sensor, a global positioning system (GPS), communication, and intelligent imaging equipment and informs a driver of the situation with sound, light, vibration, or the like for the driver to control the vehicle or detect a risk factor in advance. That is, ADAS is a term that collectively refers to technologies in which the vehicle itself recognizes various situations occurring during the driving of the vehicle and determines the situation to control a mechanical device.

Meanwhile, technology of the ADAS sensor may be classified into a radar, an ultrasound, a light detection and ranging (LiDAR), and a camera.

The radar sensor may detect an object by measuring time taken to transmit a radio wave.

The ultrasonic sensor may calculate a distance to an object by using a reflected sound wave.

The LiDAR sensor may detect a distance for each point by using the same principle as that of the radar sensor, i.e., by using a time difference between emission of a laser and its return to a receiver. The LiDAR sensor having a high angular resolution may precisely measure the distance, and detect the distance to the ground surface by measuring return time of the laser to the receiver.

Referring to FIG. 3B again based thereon, the control unit 200 may emit the laser at P. Q. R positions, which are coordinates of the surrounding region of the mobile with respect to the ground based on the predetermined surrounding region of the mobile through the ADAS sensor to detect the distance by using the time difference when the laser returns to the receiver. Accordingly, the position coordinates of P may be (X1, Y1, d1), the position coordinates of Q may be (X2, Y2, d2), and the position coordinates of R may be (X3, Y3, d3). The control unit 200 may calculate the plane data for a plane including the position coordinates of P, Q. and R based on these position coordinates.

Hereinafter, the description describes a method for calculating the inclination of the mobile by the control unit 200 in more detail through various examples.

### Example 1

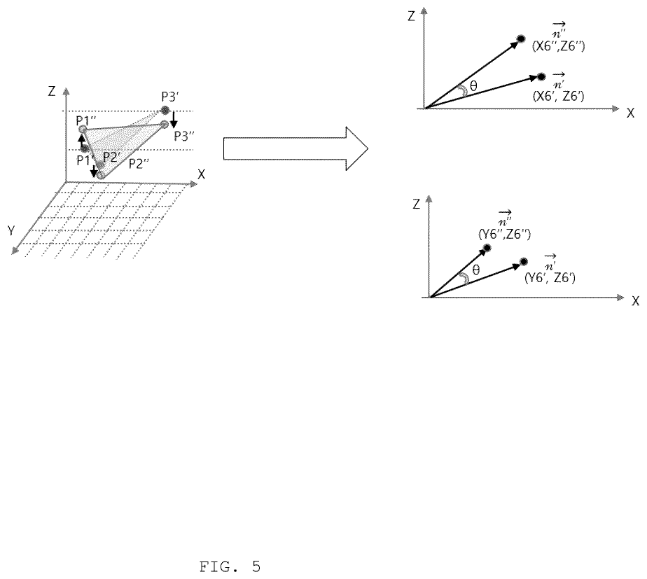

FIG. 5 is a schematic view showing Example 1 of a method for estimating the inclination of the mobile according to the present disclosure.

As shown in FIG. 5, the control unit 200 may calculate the 3D inclination of the mobile by comparing a predetermined reference normal of calculated plane data with a predetermined reference normal of reference plane data.

In detail, the control unit 200 may calculate the inclination by using a normal vector of two line segments formed by the position coordinates of the three or more points and a normal vector of two predetermined line segments of the reference plane data.

In more detail, the control unit 200 may calculate each normal vector for the vector of the two line segments serving as a basis of the position coordinates of the three or more points and the vector of the two line segments changed when the inclination of the mobile occurs. Here, the control unit 200 may calculate the normal vector through a cross product of the vector, and calculate the inclination by using an inclination difference of the calculated normal vector.

For example, it may be assumed that initial position coordinates are P1′, P2′, and P3′, and the position coordinates are P1′=(X1′, Y1′, Z1′), P2′=(X2′, Y2′, Z2′), and P3′=(X3′, Y3′, Z3′). Here, the position coordinates changed as the inclination of the mobile occurs may respectively be assumed as P1″=(X1″, Y1″, Z1″), P2″=(X2″, Y2″, Z2″), and P3″=(X3″, Y3″, Z3″).

When each of the above-described initial position coordinates is expressed as a vector, the vector may be calculated as follows:

$$\begin{matrix}\vec{{p}_{12}^{′}} = ( X {2}^{′} , Y {2}^{′} , Z {2}^{′} ) - ( X {1}^{′} , Y {1}^{′} , Z {1}^{′} ) & \vec{{p}_{13}^{′}} = ( X {3}^{′} , Y {3}^{′} , Z {3}^{′} ) - ( X {1}^{′} , Y {1}^{′} , Z {1}^{′} ) \\ = ( X {4}^{′} , Y {4}^{′} , Z {4}^{′} ) & ( X {5}^{′} , Y {5}^{′} , Z {5}^{′} )\end{matrix} .$$

In addition, the normal vector of the two line segments may be calculated as follows through the cross product of the vector:

$$\begin{matrix}\vec{{n}^{′}} = ( X {4}^{′} , Y {4}^{′} , Z {4}^{′} ) \times ( X {5}^{′} , Y {5}^{′} , Z {5}^{′} ) \\ = ( X {6}^{′} , Y {6}^{′} , Z {6}^{′} )\end{matrix} .$$

Meanwhile, when each of the above-described changed position coordinates is expressed as a vector, the vector may be calculated as follows:

$$\begin{matrix}\vec{{p}_{12}^{″}} = ( X {2}^{″} , Y {2}^{″} , Z {2}^{″} ) - ( X {1}^{″} , Y {1}^{″} , Z {1}^{″} ) & \vec{{p}_{13}^{″}} = ( X {3}^{″} , Y {3}^{″} , Z {3}^{″} ) - ( X {1}^{″} , Y {1}^{″} , Z {1}^{″} ) \\ = ( X {4}^{″} , Y {4}^{″} , Z {4}^{″} ) & ( X {5}^{″} , Y {5}^{″} , Z {5}^{″} )\end{matrix} .$$

In addition, the normal vector of the two line segments may be calculated as follows through the cross product of the vector:

$$\begin{matrix}\vec{{n}^{″}} = ( X {4}^{″} , Y {4}^{″} , Z {4}^{″} ) \times ( X {5}^{″} , Y {5}^{″} , Z {5}^{″} ) \\ = ( X {6}^{″} , Y {6}^{″} , Z {6}^{″} )\end{matrix} .$$

Accordingly, the inclination of the two normal vectors may be calculated by separating each coordinate into components of X⊥Z axes and Y⊥Z axes, respectively, and calculating an inclination between the front and rear sides of the mobile and an inclination between the left and right sides of the mobile.

In more detail, respective equations for calculating the inclinations are as shown in Equations 1 and 2 below:

$$⊖ xz = {cos}^{- 1} ( \frac{\vec{{n}^{′}} \vec{{n}^{″}}}{‖ \vec{{n}^{′}} ‖ ‖ \vec{{n}^{″}} ‖} ) , \qquad Equation 1$$

$$and$$

$$⊖ yz = {cos}^{- 1} ( \frac{\vec{{n}^{′}} \vec{{n}^{″}}}{‖ \vec{{n}^{′}} ‖ ‖ \vec{{n}^{″}} ‖} ) . \qquad Equation 2$$

### Example 2

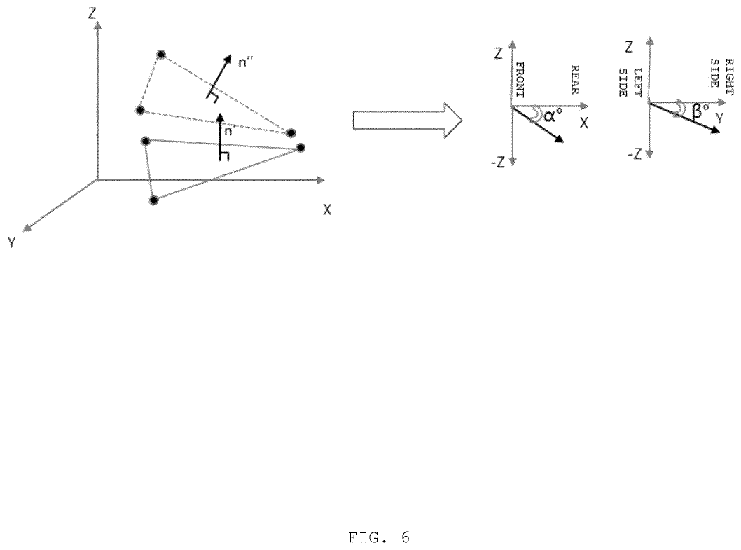

FIG. 6 is a schematic view showing Example 2 of the method for estimating an inclination of a mobile according to the present disclosure.

Next, as shown in FIG. 6, the control unit 200 may calculate the inclination by using a normal vector of a first plane formed by the position coordinates of the three or more points.

In detail, the control unit 200 may calculate each normal vector of the first plane and a second plane which is a plane changed when the inclination of the mobile occurs based on a plane equation. In addition, the control unit 200 may calculate the inclination by using the inclination difference of the normal vector.

For example, it may be assumed that the initial position coordinates are P1′, P2′, and P3′, and the position coordinates are P1′=(X1′, Y1′, Z1′), P2′=(X2′, Y2′, Z2′), and P3′=(X3′, Y3′, Z3′). Here, the position coordinates changed as the inclination of the mobile occurs may respectively be assumed as P1″=(X1″, Y1″, Z1″), P2″=(X2″, Y2″, Z2″), and P3″=(X3″, Y3″, Z3″).

The plane equation may be expressed as Equation 3 below:

$$Ax + By + Cz + D = 0. \qquad Equation 3$$

In addition, the normal vector of the plane may be expressed as follows:

$$\vec{𝓃} = ( A , B , C ) .$$

Here, values of A, B, and C may be calculated through Equation 4 below:

$$\begin{matrix}A = y 1 ( z 2 - z 3 ) + y 2 ( z 3 - z 1 ) + y 3 ( z 1 - z 2 ) \\ B = z 1 ( x 2 - x 3 ) + z 2 ( x 3 - x 1 ) + z 3 ( x 1 - x 2 ) \\ C = x 1 ( y 2 - y 3 ) + x 2 ( y 3 - y 1 ) + x 3 ( y 1 - y 2 ) \\ - D = x 1 ( y 2 z 3 - y 3 z 2 ) + x 2 ( y 3 z 1 - y 1 z 3 ) + x 3 ( y 1 z 2 - y 2 z 1 )\end{matrix} . \qquad Equation 4$$

It is thus possible to respectively calculate the initial normal vector of the initial position coordinates P1′, P2′, P3′ and the changed normal vector of the changed position coordinates P1″, P2″, P3″.

The initial normal vector may be \vec{n}′=(A1, B1, C1), and the changed normal vector may be \vec{n}″=(A1, B1, C1).

The inclination between the front and rear sides of the mobile and the inclination between the left and right sides of the mobile may be calculated by separating each coordinate into the components of the X⊥Z axes and the Y⊥Z axes, respectively.

Detailed methods of calculating the inclination may be the same as in Equations 1 and 2 above.

### Example 3

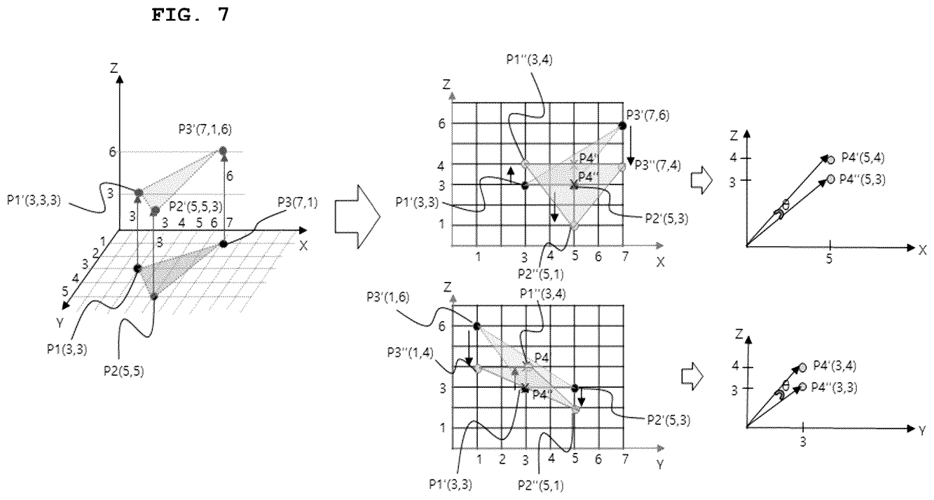

FIG. 7 is a schematic view showing Example 3 of the method for estimating an inclination of a mobile according to the present disclosure.

As shown in FIG. 7, the control unit 200 may calculate one first reference point based on position coordinates of three or more points, and calculate the inclination based on the first reference point.

In detail, when the inclination of the mobile occurs, the control unit 200 may separate a second reference point where the first reference point is changed and the first reference point into the components of the X⊥Z axes and the Y⊥Z axes, respectively, and calculate the inclination through a dot product of each vector.

Here, the reference point may be the center of gravity, incenter, or circumcenter.

In more detail, the description describes the method of calculating the inclination of the mobile by using the center of gravity of a triangle. The position coordinates of three points having X-axis and Y-axis coordinate values that are received from the sensor unit 100 may be P1 (3,3), P2 (5,5), and P3 (7,1), respectively. In this case, the control unit 200 may generate the position coordinates of the three points by calculating a Z-axis coordinate value, which is a distance of each coordinate to a road surface. Here, the finally generated position coordinates of the three points may be P1′ (3,3,3), P2′ (5,5,3), and P3′ (7,1,6). Here, an inclination of the plane may be determined by the Z-axis coordinate value.

As shown in FIG. 7, when the inclination of the mobile occurs, P4′ (5,4), which is an initial center of gravity with respect to the X⊥Z axes, may be changed to P4″ (5,3). In addition, P4′ (3,4), which is the initial center of gravity with respect to the Y⊥Z axes, may be changed to P4″ (3,3). Accordingly, the control unit 200 may calculate a change in the inclination through the dot product of each vector.

The dot product of the vectors may be calculated as in Equation 5 below:

$$⊖ = {cos}^{- 1} ( \frac{x 1 y 1 + x 2 y 2}{‖ x ‖ ‖ y ‖} ) . \qquad Equation 5$$

Through Equation 5, it may be seen that the X and Z axes are inclined at an angle of 0.14°, and the Y and Z axes are inclined at an angle of 0.15°.

### Example 4

Next, the control unit 200 may calculate the inclination by using an orthogonal projection of a plane formed by three or more position coordinates.

In detail, the control unit 200 may calculate the inclination by separating coordinates of the plane and coordinates of the plane changed when the inclination of the mobile occurs into the components of the X⊥Z axes and the Y⊥Z axes, respectively, and using an area of a surface area of each component.

For example, it may be assumed that the initial position coordinates are P1′, P2′, and P3′, and the position coordinates are P1′=(X1′, Y1′, Z1′), P2′=(X2′, Y2′, Z2′), and P3′=(X3′, Y3′, Z3′). Here, the position coordinates changed as the inclination of the mobile occurs may respectively be assumed as P1″=(X1″, Y1″, Z1″), P2″=(X2″, Y2″, Z2″), and P3″=(X3″, Y3″, Z3″).

Here, the control unit 200 may separate each coordinate into the components of the X⊥Z axes and Y⊥Z axes, respectively, and calculate the inclination based on the area of the surface area of each component. (S′ indicates an initial area, S″ indicates an area of the orthogonally projected plane).

Here, the area of the surface area may be calculated through Equations 6, 7, 8, and 9 below:

$${S}^{′} xz = \vert \frac{1}{2} ( x {1}^{′} z {2}^{′} + z {1}^{′} x {3}^{′} + z {3}^{′} x {2}^{′} - z {2}^{′} x {3}^{′} - z {1}^{′} x {2}^{′} - x {1}^{′} z {3}^{′} ) \vert , \qquad Equation 6$$

$${S}^{″} xz = \vert \frac{1}{2} ( x {1}^{″} z {2}^{″} + z {1}^{″} x {3}^{″} + z {3}^{″} x {2}^{″} - z {2}^{″} x {3}^{″} - z {1}^{″} x {2}^{″} - x {1}^{″} z {3}^{″} ) \vert , \qquad Equation 7$$

$${S}^{′} yz = \vert \frac{1}{2} ( y {1}^{′} z {2}^{′} + z {1}^{′} y {3}^{′} + z {3}^{′} y {2}^{′} - z {2}^{′} y {3}^{′} - z {1}^{′} y {2}^{′} - y {1}^{′} z {3}^{′} ) \vert , \qquad Equation 8$$

$$and$$

$${S}^{″} yz = \vert \frac{1}{2} ( y {1}^{″} z {2}^{″} + z {1}^{″} y {3}^{″} + z {3}^{″} y {2}^{″} - z {2}^{″} y {3}^{″} - z {1}^{″} y {2}^{″} - y {1}^{″} z {3}^{″} ) \vert . \qquad Equation 9$$

In addition, the control unit 200 may calculate the inclination of the X⊥Z axes and the Y⊥Z axes by using the calculated areas. Here, an angle formed by the two planes may be calculated through Equations 10 and 11 below:

$$⊖ xz = {cos}^{- 1} ( \frac{{S}^{′} xz}{{S}^{″} xz} ) , and \qquad Equation 10$$

$$⊖ yz = {cos}^{- 1} ( \frac{{S}^{′} yz}{{S}^{″} yz} ) . \qquad Equation 11$$

### Example 5

Meanwhile, the sensor unit 100 may include two or more sensors. The control unit 200 may estimate the 3D inclination based on distance values of respective points on the ground that are measured by the two or more sensors.

In detail, each sensor may detect three or more coordinates on the same ground surface, and the control unit 200 may calculate the plane data including the same.

The control unit 200 may then detect a predetermined center point of the plane formed by the three or more coordinates and a vector in which the center point is changed to estimate the three-dimensional inclination based on an inclination angle of each axis X, Y, or Z.

### Example 6

In addition, the control unit 200 may calculate the 3D inclination of the mobile in the various embodiments as described above, thus controlling the leveling module 300 included in the mobile.

In detail, according to the present disclosure, the control unit 200 may detect the three-dimensional inclination including the left and right inclination of the mobile as well as its front and rear inclination, and thus individually control steering angles of left and right lamps based on the inclination to each axis.

For example, the left and right lamps may have the same upward beam pattern when the front and rear inclination occurs, and the control unit 200 may thus control the left and right lamps to have the same angle.

On the other hand, when only one wheel crosses a bump, the control unit 200 may additionally control only a lamp in the corresponding direction. In addition, the control unit 200 may not need to additionally control the other lamp not crossing the bump.

### Example 7

In addition, the control unit 200 may further calculate position information of an object positioned in front of the mobile based on the detection data received from the sensor unit 100.

The control unit 200 may then set a dark zone based on the calculated position information of the object.

Here, the dark zone is to minimize glare to a driver of a front vehicle by lowering illuminance of a predetermined region in the beam pattern emitted based on a position of the front vehicle.

In detail, matrix coordinates to be controlled may be changed by the inclination of the vehicle. For example, when controlling an adaptive driving beam (ADB), a position where the dark zone is to be formed may deviate due to the inclination of the vehicle.

Therefore, the control unit 200 may correct the position of the dark zone to be formed by reflecting the three-dimensional inclination of the mobile calculated in the various embodiments described above.

### Example 8

Meanwhile, in a case of a lamp displaying road surface information, when the inclination occurs between the road surface and the vehicle body, a projected image may be distorted because a projection angle of light to the ground is changed.

Accordingly, the control unit 200 may estimate the distortion of an image projected in front of the mobile based on the calculated 3D inclination, and correct the distortion of the image in hardware or software.

In detail, the control unit 200 may perform the correction by controlling the leveling module 300 based on the calculated 3D inclination, or normalize the distorted image by using image warping.

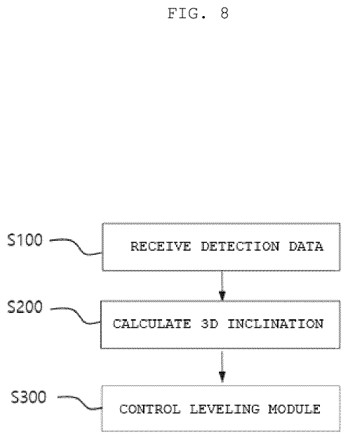

FIG. 8 is a flowchart showing a control method of a headlamp auto leveling system for a mobile according to the present disclosure.

As shown in FIG. 8, the control method of the headlamp auto leveling system 1000 for a mobile that includes the leveling module 300 and the sensor unit 100 according to the present disclosure may include: a step S100 of receiving, by the control unit 200, the detection data from the sensor unit 100; a step S200 of calculating, by the control unit 200, the 3D inclination of the mobile based on the received detection data; and a step S300 of controlling, by the control unit 200, the leveling module 300 based on the calculated 3D inclination.

In detail, in the step S200, the control unit 200 may generate the three or more position coordinates, and calculate the plane data of the predetermined surrounding region of the mobile based on the detection data including the generated position coordinates of the three or more points.

In addition, the control unit 200 may calculate the three-dimensional inclination, which is the three-dimensional inclination of the front, rear, left, and right of the mobile with respect to the X. Y, and Z axes by comparing the predetermined reference plane data with the calculated plane data.

Here, the X. Y, and Z axes may be the axes perpendicular to one another.

The description describes a method for the control unit 200 to calculate the 3D inclination in step S200 through various examples below.

In the step S200, the control unit 200 may calculate one first reference point based on the plane data based on the three or more position coordinates, and calculate the inclination based on the first reference point.

In detail, when the inclination of the mobile occurs, the control unit 200 may separate the second reference point where the first reference point is changed and the first reference point into the components of the X⊥Z-axes and the Y⊥Z-axes, respectively, and calculate the inclination through the dot product of each vector.

Here, the reference point may be the center of gravity, the incenter, or the circumcenter.

In more detail, the description describes the method of calculating the inclination of the mobile by using the center of gravity of the triangle. The position coordinates of the three points having the X-axis and Y-axis coordinate values that are received from the sensor unit 100 may be P1 (3,3), P2 (5,5), and P3 (7,1), respectively. In this case, the control unit 200 may generate the position coordinates of the three points by calculating the Z-axis coordinate value, which is the distance of each coordinate to the road surface. Here, the finally generated position coordinates of the three points may be P1′ (3,3,3), P2′ (5,5,3), and P3′ (7,1,6). Here, the inclination of the plane may be determined by the Z-axis coordinate value.

As shown in FIG. 7, when the inclination of the mobile occurs, the initial center of gravity P4′ (5,4) with respect to the X⊥Z axes may be changed to P4″ (5,3). In addition, P4′ (3,4), which is the initial center of gravity with respect to the Y⊥Z axes, may be changed to P4″ (3,3). Accordingly, the control unit 200 may calculate the change in the inclination through the dot product of each vector.

For another example, in the step S200, the control unit 200 may calculate the 3D inclination of the mobile by comparing the predetermined reference normal of the calculated plane data with the predetermined reference normal of the reference plane data.

In detail, the control unit 200 may calculate the inclination by using the normal vector of the two line segments formed by the position coordinates of the three or more points and the normal vector of two predetermined line segments of the reference plane data.

In more detail, the control unit 200 may calculate each normal vector for the vector of the two line segments serving as the basis of the position coordinates of the three or more points and the vector of the two line segments changed when the inclination of the mobile occurs. Here, the control unit 200 may calculate the normal vector through the cross product of the vector, and calculate the inclination by using the inclination difference of the calculated normal vector.

For another example, in the step S200, the control unit 200 may calculate the inclination by using the normal vector of the first plane formed by the position coordinates of the three or more points.

In detail, the control unit 200 may calculate each normal vector of the first plane and the second plane which is the plane changed when the inclination of the mobile occurs based on the plane equation. In addition, the control unit 200 may calculate the inclination by using the inclination difference of the normal vector.

For another example, in the step S200, the control unit 200 may calculate the inclination by using the orthogonal projection of the plane formed by the three or more position coordinates.

In detail, the control unit 200 may calculate the inclination by separating the coordinates of the plane and the coordinates of the plane changed when the inclination of the mobile occurs into the components of the X⊥Z axes and the Y⊥Z axes, respectively, and using the area of the surface area of each component.

For another example, in the step S200, the control unit 200 may estimate the 3D inclination based on the distance values of the respective points on the ground that are measured by the two or more sensors.

In detail, each sensor may detect the three or more coordinates on the same ground surface, and the control unit 200 may calculate the plane data including the same.

The control unit 200 may then detect the predetermined center point of the plane formed by the three or more coordinates and the vector in which the center point is changed to estimate the three-dimensional inclination based on the inclination angle of each axis X, Y, or Z.

In the step S300, the control unit 200 may control the leveling module 300 based on the 3D inclination calculated in the various embodiments as described above.

In detail, according to the present disclosure, the control unit 200 may detect the three-dimensional inclination including the left and right inclination of the mobile as well as its front and rear inclination, and thus individually control the steering angles of the left and right lamps based on the inclination to each axis.

For example, the left and right lamps may have the same upward beam pattern when the front and rear inclination occurs, and the control unit 200 may thus control the left and right lamps to have the same angle.

On the other hand, when only one wheel crosses the bump, the control unit 200 may additionally control only the lamp in the corresponding direction. In addition, the control unit 200 may not need to additionally control the other lamp not crossing the bump.

In addition, after step S200 and before step S300, the control unit 200 may further calculate the position information of the object positioned in front of the mobile based on the detection data received from the sensor unit 100.

The control unit 200 may then set the dark zone based on the calculated position information of the object.

Here, the dark zone is to minimize glare to the driver of the front vehicle by lowering the illuminance of the predetermined region in the beam pattern emitted based on the position of the front vehicle.

In detail, the matrix coordinates to be controlled may be changed by the inclination of the vehicle. For example, when controlling the adaptive driving beam (ADB), the position where the dark zone is to be formed may deviate due to the inclination of the vehicle.

Therefore, the control unit 200 may correct the position of the dark zone formed by reflecting the three-dimensional inclination of the mobile calculated in the various embodiments described above.

Meanwhile, in the case of the lamp displaying the road surface information, when the inclination occurs between the road surface and the vehicle body, the projected image may be distorted because the projection angle of light to the ground is changed.

Accordingly, after step S200 and before step S300, the control unit 200 may estimate the distortion of the image projected in front of the mobile based on the calculated 3D inclination, and correct the distortion of the image in hardware or software.

In detail, the control unit 200 may perform the correction by controlling the leveling module 300 based on the calculated 3D inclination, or normalize the distorted image by using the image warping.

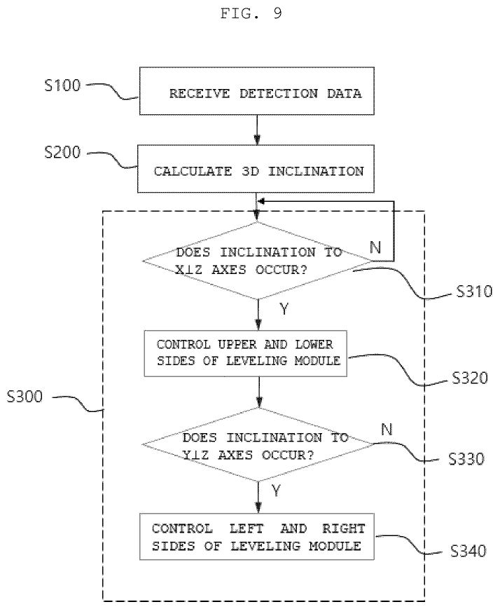

FIG. 9 is a flow chart showing FIG. 8 in more detail.

As shown in FIG. 9, the step S300 may include: a step S310 of determining whether the inclination to the X axis (or a first reference axis) and the Z axis (or a second reference axis) occurs in the calculated 3D inclination; a step S320 of controlling upper and lower sides of the leveling module 300 when a first angle which is the inclination to the X and Z axes has a predetermined reference or more; a step S330 of determining whether the inclination to the Y axis (or a third reference axis) and the Z axis occurs; and a step S340 of controlling left and right sides of the leveling module 300 when a second angle which is the inclination to the Y and Z axes has a predetermined reference or more.

Here, the X, Y, and Z axes may be the axes perpendicular to one another.

As set forth above, the headlamp auto leveling system for a mobile and the control method thereof according to the various embodiments of the present disclosure may more precisely control the leveling of the mobile compared to the leveling control of the mobile by using the conventional height sensor.

In addition, the system and the method thereof according to the present disclosure may lower the cost by replacing the conventional height sensor with the ADAS sensor.

Although the embodiments of the present disclosure are described as above, the embodiments disclosed in the present disclosure are provided not to limit the spirit of the present disclosure, but to fully describe the present disclosure. Therefore, the spirit of the present disclosure may include not only each disclosed embodiment but also a combination of the disclosed embodiments. Further, the scope of the present disclosure is not limited by these embodiments. In addition, it is apparent to those skilled in the art to which the present disclosure pertains that various variations and modifications could be made without departing from the spirit and scope of the appended claims, and all such appropriate variations and modifications should be considered as falling within the scope of the present disclosure as equivalents.

What is claimed is:

1. A headlamp auto leveling system for a vehicle that includes a headlamp, the system comprising:
a leveling module configured to control an inclination of the headlamp;
a sensor unit including at least one of a light detection and ranging (LiDAR), a radar unit, and a camera configured to provide detection data of a surrounding environment of the vehicle; and
a control unit configured to determine a three-dimensional (3D) inclination of the vehicle with respect to a ground based on the detection data received from the sensor unit, and to control the leveling module based on the 3D inclination of the vehicle,
wherein the control unit is configured to determine plane data for a predetermined surrounding region of the vehicle from the detection data received from the sensor unit, and to calculate the 3D inclination of the vehicle by comparing predetermined reference plane data with the determined plane data.

2. The system of claim 1, wherein the control unit is configured to determine coordinates of the ground of the predetermined surrounding region based on the predetermined surrounding region of the vehicle, and to determine the plane data for a plane including the coordinates.

3. The system of claim 2, wherein the control unit is configured to determine the 3D inclination of the vehicle by comparing a predetermined reference normal of the determined plane data with a predetermined reference normal of the reference plane data.

4. The system of claim 2, wherein the control unit is configured to determine the 3D inclination of the vehicle by comparing a predetermined center of gravity of the determined plane data with a predetermined center of gravity of the reference plane data.

5. The system of claim 2, wherein the control unit is configured to determine the 3D inclination of the vehicle by comparing a predetermined area of the determined plane data with a predetermined area of the reference plane data.

6. The system of claim 1, wherein the sensor unit includes at least two or more sensors, and the control unit is configured to determine the plane data from the detection data received from the at least two or more sensors, and to determine the 3D inclination of the vehicle by comparing a predetermined center point of the determined plane data with a predetermined center point of the reference plane data.

7. The system of claim 1, wherein the headlamp includes a plurality of headlamps, and the control unit is configured to control the leveling module to individually control angles of the plurality of headlamps based on the calculated 3D inclination of the vehicle.

8. The system of claim 1, wherein the control unit is further configured to determine position information of an object positioned in front of the vehicle based on the detection data received from the sensor unit, to set a dark zone based on the determined position information of the object, and to correct a position of the dark zone based on the determined 3D inclination of the vehicle.

9. The system of claim 1, wherein the control unit is configured to estimate distortion of an image projected in front of the vehicle based on the calculated 3D inclination, and to correct the image to be in a direction opposite that of the estimated distortion.

10. A control method of a headlamp auto leveling system for a vehicle that includes a leveling module and a sensor unit, the method comprising:
(a) receiving, by a control unit, detection data from the sensor unit;
(b) determining, by the control unit, a three-dimensional (3D) inclination of the vehicle with respect to a ground based on the received detection data; and
(c) controlling, by the control unit, the leveling module based on the determined 3D inclination of the vehicle,
wherein in step (b), plane data for a predetermined surrounding region of the vehicle is determined from the detection data received from the sensor unit, and
the 3D inclination of the mobile is determined by comparing predetermined reference plane data with the calculated plane data.

11. The method of claim 10, wherein, in step (b), coordinates of the ground of the predetermined surrounding region are determined based on the predetermined surrounding region of the vehicle, and the plane data for a plane including the coordinates is determined.

12. The method of claim 11, wherein, in step (b), the 3D inclination of the vehicle is determined by comparing any one of the predetermined reference normal, center of gravity, and area of the determined plane data with any one of the predetermined reference normal, center of gravity, and area of the reference plane data, respectively.

13. The method of claim 11, wherein step (c) includes:
determining a first angle of the calculated 3D inclination which is an inclination to a first reference axis and a second reference axis which is an axis perpendicular to the first reference axis;
controlling upper and lower sides of the leveling module when the first angle is of a first predetermined reference amount or greater;
determining a second angle of the calculated 3D inclination which is an inclination to the second reference axis and a third reference axis which is an axis perpendicular to the second reference axis; and
controlling left and right sides of the leveling module when the second angle is of a second predetermined reference angle or greater.
